(19) United States
(12) Patent Application Publication
(10) Pub. No.: US 2024/0391610 A1
(43) Pub. Date: Nov. 28, 2024

(54) SATELLITE, SATELLITE ASSEMBLY AND METHOD OF DEPLOYING SATELLITES FROM A SATELLITE ASSEMBLY

(71) Applicant: UNIVERSITY OF MALTA, Msida (MT)

(72) Inventors: Daniel CUMBO, Qawra (MT); Marc Anthony AZZOPARDI, San Gwann (MT)

(73) Assignee: UNIVERSITY OF MALTA, Msida (MT)

(21) Appl. No.: 18/673,290

(22) Filed: May 23, 2024

Related U.S. Application Data
(60) Provisional application No. 63/468,453, filed on May 23, 2023.

(51) Int. Cl. B64G 1/10; B64G 1/64

(52) U.S. Cl. CPC B64G 1/1085; B64G 1/644; B64G 1/645

(57) ABSTRACT

The disclosure concerns a satellite for inclusion in a satellite assembly comprising a plurality of satellites for deployment in space. The satellite comprising a satellite disengagement mechanism configured to separate the satellite from one or more adjacent satellites of the satellite assembly. The satellite disengagement mechanism comprises one or more disengagement coils configured to generate a repulsive electromagnetic force to separate the satellite from the one or more adjacent satellites.

### CROSS-REFERENCE TO RELATED APPLICATION

This application claims the benefit of U.S. Provisional Application No. 63/468,453 filed on May 23, 2023. The entire disclosure of the above application is incorporated herein by reference.

### FIELD

The present invention relates to a satellite assembly and a satellite for inclusion in a satellite assembly. The invention also relates to a method of deploying satellites from a satellite assembly.

### BACKGROUND

This section provides background information related to the present disclosure which is not necessarily prior art.

A CubeSat is a class of nanosatellite created with the intention of reducing the cost and increasing access to space and space technologies. CubeSats are based around a format consisting of cubes, with a “1U” CubeSat having sides of approximately 10 cm (3.9 in) in length. Variations on the CubeSat have since been developed. For example, larger satellites have been created based on the CubeSat form, by creating satellites of “2U”, 10 cm×10 cm×20 cm, or “3U”, 10 cm×10 cm×30 cm, dimension.

A Poly Pico-Satellite Orbital Deployment system (P-POD) is a standard apparatus for the dispensing of CubeSat satellites into orbit. The P-POD accommodates a 3U CubeSat, or equivalently, three 1U CubeSats, or equivalently, a 1U CubeSat and a 2U CubeSat. Similarly, the Innovative Solutions in Space Pico-Satellite Orbital Deployment system (ISISPOD) was designed for the dispensing of CubeSats and serves the same function as the aforementioned P-POD.

Widespread adoption of the CubeSat format resulted in an increase in the associated launch costs thus lessening the advantages relating to cost savings and accessibility of CubeSat form satellites. A PocketQube is a pico-satellite designed by Cal Poly to address the increase in costs of CubeSat deployment, by reducing the weight and volume of the satellite to approximately an eighth that of the CubeSat, in other words a “1p” PocketQube has dimensions of approximately 5 cm×5 cm×5 cm. With similar concepts to the P-POD, the MR-FOD and Albapod were designed to dispense PocketQubes into orbit. However, due to the limitations in miniaturisation from P-POD type deployment systems to MR-FOD type deployment systems, only four 1p PocketQubes replace a 1U CubeSat with current technology, despite being an eighth in mass and volume. This does not optimise for volume, which is costly for launch vehicles, and thus does not optimize the cost savings per launch.

“Intersatellite Separation Mechanism for the JC2Sat Formation Flying Mission” (Lambert et al., Journal of Spacecraft and Rockets, Vol. 48 No. 4) discloses on-orbit separation and dispersal of small satellites. The satellites initially reach orbit together in a stacked configuration before the two satellites are separated from one another and dispersed using differential nodal precession and differential drag. The disengagement mechanism used to separate the satellites comprises springs to force the satellites apart.

### SUMMARY

This section provides a general summary of the disclosure, and is not a comprehensive disclosure of its full scope or all of its features.

It is an object of the disclosure to provide efficient and cost-effective systems and methods for setting a plurality of satellites, particularly picosatellites, into orbit and dispersing the satellites on respective trajectories.

According to an aspect of the invention, there is provided a satellite for inclusion in a satellite assembly comprising a plurality of satellites for deployment in space. The satellite comprises a satellite disengagement mechanism configured to separate the satellite from one or more adjacent satellites of the satellite assembly. The satellite disengagement mechanism comprises one or more disengagement coils configured to generate a repulsive electromagnetic force to separate the satellite from the one or more adjacent satellites. In this arrangement, electromagnetic disengagement coils may provide a large repulsive force in a short duration. As such, a significant repulsive force may be imparted to the satellite before it becomes too far from the remaining satellites for the force to be effective on the separated satellite. Furthermore, the satellites may be effectively and efficiently repelled away and set on different trajectories with a relatively low risk of damage to the satellites during separation due, for example, to the low number of moving mechanical parts of the disengagement mechanism.

In an embodiment, the satellite disengagement mechanism further comprises a disengagement controller. The disengagement controller comprises a bulk capacitor, and a driver circuit configured to discharge an electric charge held within the bulk capacitor through the one or more disengagement coils to induce a magnetic field in the one or more disengagement coils. In this arrangement, the repulsive force may also be readily controlled to impart the desired amount of force during each separation.

In an embodiment, the one or more disengagement coils comprises a plurality of disengagement coils. The driver circuit is configured to discharge the electric charge held within the bulk capacitor through the plurality of disengagement coils simultaneously. The satellites may further comprise at least one connection pin configured to provide an electrical connection between the satellite and the one or more adjacent satellites. The driver circuit may be configured to discharge the electric charge held within the bulk capacitor through the plurality of disengagement coils in response to receiving a synchronisation signal through the at least one connection pin. In this arrangement, a plurality of disengagement mechanisms may be simply controlled to activate simultaneously to increase the repulsive force applied to separate away the satellites, or sub-cluster, being separated. This reduces the likelihood of a failed separation and increases the distance between the separated and remaining satellite(s) such that the satellites may be set on different orbital trajectories and provide the desired coverage above Earth, or any other planet.

In an embodiment, each satellite disengagement mechanism comprises three disengagement coils. Each of the three disengagement coils is preferably disposed on a different side of the satellite, wherein each of the three sides of the satellite is configured to face a side of an adjacent satellite prior to separation.

In an embodiment, one or more of the disengagement coils is configured to contribute to attitude control of the satellite using magnetic torque. In this arrangement, the number of different components, and thus the weight and launch cost, of the satellite may be reduced by the coils serving multiple functions of disengagement and attitude control. This may have the additional benefit of efficiently using the limited space in the satellite frame.

According to an aspect of the invention, there is provided a satellite assembly comprising one or more clusters of satellites. Each cluster of satellites comprises a plurality of satellites arranged in a 1U satellite frame. Each cluster of satellites is configured such that the satellites separate from each other sequentially. This arrangement may provide a plurality of satellites that can be deployed in a single launch as a single satellite assembly, making efficient use of launch services. The satellite assembly may be deployed from a single standardised and widely available deployment system, rather than requiring a bespoke deployment system. The satellites may then be separated from the cluster in a desired order in order to be dispersed to individual orbits and trajectories. With this approach, an entire constellation of satellites can be deployed at once at relatively low cost, low complexity, and adaptability to a wide variety of applications.

In an embodiment, each cluster comprises eight or more satellites. Each cluster may comprise a two-by-two-by-two array of satellites.

In an embodiment, the satellite assembly comprises a plurality of clusters, and the satellite assembly is configured such that the clusters separate from each other sequentially.

In an embodiment, each satellite comprises a plurality of guide pins and guide holes, wherein the guide pins of each satellite are configured to insert into corresponding guide holes of one or more adjacent satellites, to align the satellite relative to the one or more adjacent satellites. The one or more clusters may comprise a plurality of clusters, and the one or more adjacent satellites may comprise at least one satellite in an adjacent cluster. One or more of the plurality of guide pins may be configured to provide an electrical connection between the satellite and the adjacent satellite.

In an embodiment, each satellite comprises at least one connection pin configured to provide an electrical connection between the satellite and an adjacent satellite. The at least one connection pin may be a spring-loaded pin. With this arrangement, the pin may serve multiple functions. In particular, the pin may provide an electrical connection, may aid in alignment between adjacent satellites, and may provide a small force to aid in separation of the adjacent satellites during disengagement.

In an embodiment, the satellite assembly comprises a satellite disengagement system configured to separate one or more satellites from a remaining one or more satellites of the satellite assembly. The satellite assembly may comprise a plurality of clusters. The satellite disengagement system may be configured to separate one or more clusters from a remaining one or more clusters of the satellite assembly.

In an embodiment, each cluster comprises two half-clusters, and the satellite disengagement system is configured to separate one of the two half-clusters from the other of the two half-clusters. Each half-cluster may comprise a two-by-two array of satellites. Each half-cluster may comprise two quarter-clusters, and the satellite disengagement system may be configured to separate one of the two quarter-clusters from the other of the two quarter-clusters. Each quarter-cluster may comprise two satellites, and the satellite disengagement system may be configured to separate one of the two satellites of the quarter-cluster from the other of the two satellites of the quarter-cluster.

In an embodiment, at least one of the satellites of the satellite assembly is a satellite according to one of the above-described aspects. Each satellite of the satellite assembly may a satellite according to one of the above-described aspects. The satellites may include a first satellite comprising a first disengagement coil and a second satellite comprising a second disengagement coil. The first disengagement coil may be disposed on a first side of the first satellite. The second disengagement coil may be disposed on a second side of the second satellite. Prior to separation, the first side and the second side face each other.

According to an aspect of the invention, there is provided a method of deploying satellites from a satellite assembly according to any of the above described aspects. The method comprises: disposing the satellite assembly inside a launch vehicle; controlling the launch vehicle to deploy the satellite assembly into an initial orbit; and controlling the satellite assembly to separate satellites from the satellite assembly in a sequence. This arrangement may provide a method of efficiently putting a plurality of satellites, in the form of a single satellite assembly, into an initial orbit. The satellite assembly may then be separated in a desired sequence in order to distribute the satellites in space according to mission requirements. The method may therefore be adaptable to different mission configurations, such that a large number of satellites may be employed simply and at low cost.

In an embodiment, the sequence includes separating satellites from the at least one cluster such that a separated sub-cluster of satellites is separated from a remaining sub-cluster. The attitude of the separated sub-cluster may be adjusted to increase an amount of differential drag between the separated sub-cluster and the remaining sub-cluster. In this way the sub-clusters, and ultimately the individual satellites, may be separated by a large distance in space with limited use of power. Thus, a constellation of satellites may be distributed onto different orbital trajectories in an efficient manner with relatively low power or fuel use.

In an embodiment, the method further comprises selecting which of the plurality of satellites are included in the sub-cluster based on an estimated differential drag of the separated sub-cluster. The sequence may include sequentially separating satellites from the separated sub-cluster until each satellite has been separated. In this way, the satellites of the satellite assembly may be separated in a desired order such that the satellites may be separated in space efficiently and set in the desired orbital trajectory for the specific mission requirements. The method may therefore be readily adaptable to different mission applications.

In an embodiment, the method further comprises further comprising setting the separated satellites into different altitudes and orbital planes using differential drag and/or using differential nodal precession. In this way, the satellites may be efficiently distributed in space while remaining largely passive. In other words, the satellites may achieve a desired distribution in space with relatively low use of fuel and/or power.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, and are not intended to limit the scope of the present disclosure.

FIG. 1 illustrates an orthogonal view of a satellite assembly comprising a cluster of eight satellites.

FIG. 2 illustrates a cross-sectional view of a satellite assembly comprising three clusters of satellites loaded into a standard deployment system.

FIG. 3A illustrates an orthogonal view of a single satellite with guide holes a mating face.

FIG. 3B illustrates an orthogonal view of a single satellite with guide pins on a mating face.

FIG. 4A-B illustrates half-clusters, separated from a cluster of satellites, set to move in different orientations.

FIG. 5A-B illustrates quarter-clusters, separated from the sub-clusters of satellites of FIGS. 4A and 4B, set to move in different orientations.

FIG. 6A-B illustrates single satellites, separated from the quarter-clusters of satellites of FIGS. 5A and 5B, set to move in different orientations.

FIG. 7 illustrates an exploded orthogonal view of the disengagement mechanism of a satellite.

Corresponding reference numerals indicate corresponding parts throughout the several views of the drawings.

### DETAILED DESCRIPTION

Example embodiments will now be described more fully with reference to the accompanying drawings.

Current deployment methods do not efficiently utilize the minimal space allocated for nano- and pico-satellites on launch vehicles. At present, launching a cluster of pico-satellites, each less than 1U in size, is limited to four satellites per available deployment system. As the availability of deployment systems for satellites of this scale are scarcely available, launching a swarm or cluster of these satellites may require multiple launches, complex launch scheduling and long periods between deployments. Furthermore, due to the inefficient use of space of the deployment systems, deployment of swarms of this scale becomes financially costly. These issues become further exacerbated when considering replenishing the swarm with additional satellites.

It is an object of the disclosure to provide efficient and cost-effective systems and methods for setting a plurality of satellites, particularly picosatellites, into orbit and dispersing the satellites on respective trajectories. This disclosure aims to provide means and methods of deploying a plurality of satellites into a plurality of orbits originating from the same initial orbit. In particular, satellite deployment and dispersal methods may include steps of:
(I) deploying a plurality of satellites as a cluster, formed of a plurality of satellites; into the initial orbit;
(II) disengaging the satellites from the cluster via a disengagement mechanism; and
(III) using attitude manoeuvres to orient sub-clusters, such that the sub-clusters experience different magnitudes of drag force and different rates of nodal precession over time, resulting in their separation in inertial space. The clusters may then be sub-divided or separated further, via disengagement mechanisms, until the plurality of deployable satellites in the original cluster are completely disengaged from the cluster.

The satellites and satellite assemblies of the present disclosure are preferably configured to be dispensed into orbit using standard, existing technology for deploying satellites of 1U size (approximately 10 cm×10 cm×10 cm), or multiples thereof. For example, deployment systems configured to deploy a 3U satellite, or a single 1U satellite together with a 2U satellite, or three 1U satellites. The standard deployment systems may be launched from known launch vehicles, and the standard deployment systems may then be used to deploy satellite clusters into an initial orbit.

### [Structure and Modular Assembly]

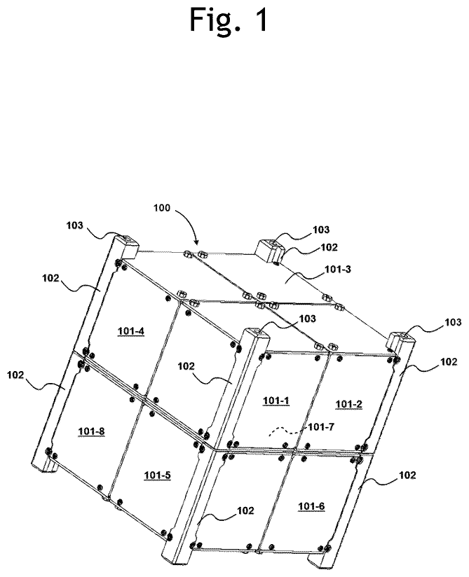

According to one arrangement, for example as shown in FIG. 1, there is a cluster 100 of eight satellites 101-1 to 101-8. In an arrangement a satellite assembly may comprise a single cluster of satellites, such as the cluster 100 shown in FIG. 1. In alternative arrangements, the satellite assembly may comprise a plurality of clusters of satellites.

Furthermore, the cluster 100 of satellites in the arrangement of FIG. 1 comprises a plurality of satellites. A cluster of satellites may comprise two or more satellites, preferably four or more satellites, and more preferably eight or more satellites. Each cluster of satellites is arranged in a 1U satellite frame. In other words, each cluster of satellites has a size of approximately 10 cm×10 cm×10 cm such that the cluster is suitable for deployment from a standard deployment system of 1U satellites, or a standard deployment system of satellites of multiples of 1U, such as 2U or 3U.

In the arrangement illustrated in FIG. 1, the cluster 100 may comprise rails 102 configured to support the satellites and optionally to provide a connection point between adjacent clusters in a satellite assembly comprising a plurality of clusters 100. The cluster 100 may also comprise one or more antennae 103. The antennae 103 are optionally housed within the rails 102.

As shown in the arrangement illustrated in FIG. 1, a cluster 100 comprising eight satellites 101-1 to 101-8 may be arranged as a two-by-two-by-two array of satellites. In this arrangement, each satellite has the same dimensions of approximately 5 cm×5 cm by 5 cm. In an alternative arrangement, a satellite cluster may comprise a different number of satellites and they may be arranged in a different configuration. For example, in an alternative arrangement, a satellite cluster may comprise nine satellites arranged in a three-by-three-by-three array of satellites. Furthermore, in another arrangement, there may be provided a satellite cluster comprising satellites of a plurality of different sizes.

In a satellite assembly comprising a plurality of clusters, each cluster may have the same configuration of satellites. For example, each cluster may comprise eight satellites in a two-by-two-by-two array of satellites, such as the cluster 100 shown in FIG. 1. Alternatively, one of more of the clusters of the satellite assembly may have a different arrangement than the arrangements of satellites of the one or more other clusters of satellites in the satellite assembly. For example, one of the pluralities of clusters may comprise of a two-by-two-by-two array of satellites while another cluster may comprise a different arrangement, for example an arrangement comprising a different number of satellites. Furthermore, in addition to comprising a cluster of satellites comprising a plurality of satellites each having a size smaller than 1U, in some arrangements the satellite assembly may also comprise a satellite of 1U and/or satellites of size greater than 1U (e.g., 2U).

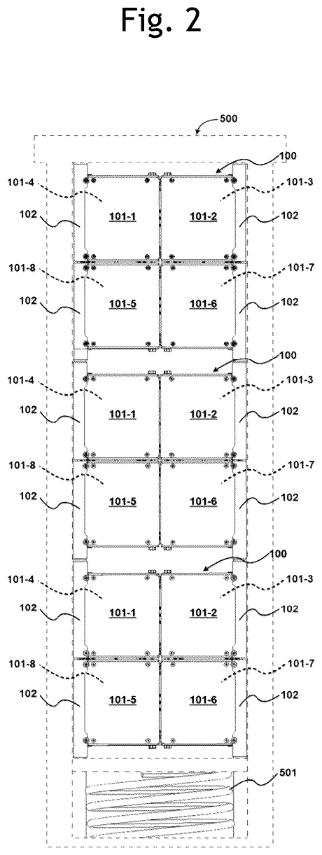

As shown in the arrangement illustrated in FIG. 2, a satellite assembly may be loaded into a deployment system 500 configured to deploy the satellite assembly into space at the desired altitude. In particular, the deployment system 500, comprises a deployment mechanism 501 configured to force the satellite assembly away from the deployment system 500. In this way, the satellite assemblies may be deployed using existing deployment system technology and the individual clusters and/or satellites comprised within each satellite assembly may be deployed at the required orbital altitude, and then dispersed at different trajectories. As such, constellations or networks of picosatellites may be put into orbit to provide coverage in a fuel efficient and cost effective manner.

In the arrangement of FIG. 2, the satellite assembly comprises three clusters 100. In the satellite assembly shown in FIG. 2, each cluster 100 is the same as the cluster 100 described above in reference to FIG. 1. In a satellites assembly such as those shown in FIG. 1 and FIG. 2, each cluster 100 of satellites is configured such that the satellites 101-1 to 101-8 separate from each other sequentially. In other words, once deployed in orbit, the satellite assembly is configured to detach one or more satellites away from the remaining satellites of the satellite assembly in a predetermined order, until each satellite has been detached from each other satellite. As a satellite is detached, it is preferably forced away from the remaining satellites such that the detached satellite is directed in different trajectory from the other satellites. The satellite assembly may comprise a satellite disengagement system configured to separate one or more satellites from a remaining one or more satellites of the satellite assembly. In other words, one or more satellites of the satellite assembly may be separated from the remaining satellites of the satellite assembly by a satellite disengagement system.

A satellite assembly comprising a plurality of clusters, for example as shown in FIG. 2, may be configured such that the clusters 100 separate from each other sequentially. In other words, once deployed in orbit, the satellite assembly is configured to detach one or more clusters 100 away from the remaining clusters 100 of the satellite assembly in a predetermined order, until each cluster 100 has been detached from each other cluster 100. As a cluster 100 is detached, it is preferably forced away from the remaining cluster(s) 100 such that the detached cluster 100 is directed in different trajectory from the other cluster(s) 100. Once the clusters 100 have been separated, the satellites 101-1 to 101-8 of each cluster may then be separated from each other sequentially, as described above. For example, the satellite disengagement system may be configured to separate one or more clusters from a remaining one or more clusters of the satellite assembly.

Each cluster 100 may be configured to be separated into a plurality of sub-clusters, wherein each sub-cluster comprises one or more satellites. In order to deploy and disperse the individual satellites, the satellite assembly may be deployed from a deployment system 500. If the satellite assembly comprises a plurality of clusters, the clusters may be separated from each other. Each cluster 100 may be allowed to drift in space for a predetermined period of time. After the predetermined time has elapsed, the cluster may be separated into sub-clusters. The sub-clusters may be allowed to disperse through differential drag and differential nodal precession. Similarly, after another predetermined delay time, the sub-clusters may be separated into further, smaller sub-clusters, and after a further predetermined delay, the smaller sub-clusters may be separated until each satellite has been separated from its cluster.

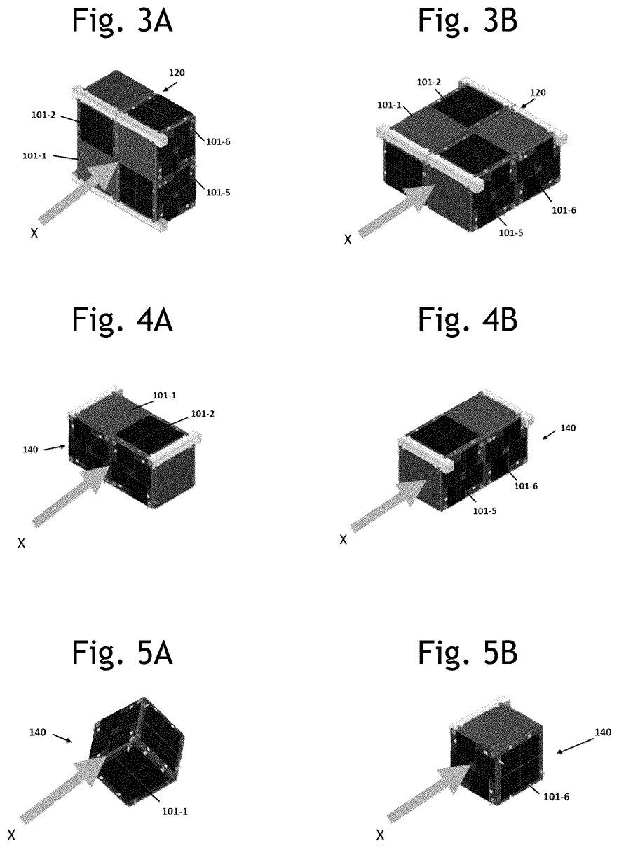

For example, each cluster 100 may be configured to separate into two half-clusters 120. FIGS. 3A and 3B show examples of a half-cluster 120 which has been separated from a cluster 100, such as the cluster 100 described above in reference to FIG. 1. In particular, the satellite disengagement system may be configured to separate one of the two half-clusters 120 from the cluster. In other words, satellite disengagement system may be configured to separate one of the two half-clusters 120 from the other of the two half-clusters, such that the two half-clusters are no longer physically connected. In the arrangement shown in FIGS. 3A and 3B, each half-cluster 120 comprises four satellites arranged in a two-by-two-by-one array of satellites 101-1, 101-2, 101-5, 101-6. FIG. 3A provides an example wherein the separated half-cluster 120 is moving in a first direction X and has a larger surface area on a front most surface, orthogonal to a direction of motion X, than on a side surface, parallel with the direction of motion X. FIG. 3B provides an example wherein the separated half-cluster 120 is moving in a first direction X and has a smaller surface area on a front most surface, orthogonal to a direction of motion X, than on a side surface, parallel with the direction of motion X.

Each half-cluster 120 may be configured to be separated into a plurality of sub-clusters, wherein each sub-cluster comprises one or more satellites. For example, each half-cluster 120 may be configured to separate into two quarter-clusters 140. FIGS. 4A and 4B show examples of a quarter-cluster 140 which has been separated from a half-cluster 120, such as the half-cluster 120 described above in reference to FIG. 3A-B. In particular, the satellite disengagement system may be configured to separate one of the two quarter-clusters 140 from the separated half-cluster 120. In other words, satellite disengagement system may be configured to separate one of the two quarter-clusters 140 from the other of the two quarter-clusters, such that the two quarter-clusters of the separated half-cluster are no longer physically connected. In the arrangement shown in FIGS. 4A and 4B, each quarter-cluster 140 comprises two satellites arranged in a two-by-one array of satellites. In particular, FIG. 4A shows a first quarter-cluster of satellites 101-1, 101-2, and FIG. 4B shows a second quarter-cluster of satellites 101-5, 101-6. FIG. 4A provides an example wherein the separated quarter-cluster 140 is moving in a first direction X and has a larger surface area on a front most surface, orthogonal to a direction of motion X, than on a side surface, parallel with the direction of motion X. FIG. 4B provides an example wherein the separated quarter-cluster 140 is moving in a first direction X and has a smaller surface area on a front most surface, orthogonal to a direction of motion X, than on a side surface, parallel with the direction of motion X.

Each quarter-cluster 140 may be configured to be separated into a plurality of sub-clusters, wherein each sub-cluster comprises one or more satellites. For example, each quarter-cluster 140 may be configured to separate into two eighth-clusters 180. FIGS. 5A and 5B show examples of an eighth-cluster 180 comprising a single satellite which has been separated from a quarter-clusters 140, such as the quarter-cluster 140 described above in reference to FIG. 4A-B. In particular, the satellite disengagement system may be configured to separate one of the two eighth-clusters 180 from the separated quarter-cluster 140. In other words, satellite disengagement system may be configured to separate one of the two eighth-clusters 180 from the other of the two eighth-clusters, such that the two eighth-clusters of the separated quarter-cluster are no longer physically connected. In the arrangement shown in FIGS. 5A and 5B, each eighth-cluster 140 comprises a single satellite. In particular, FIG. 5A shows a first satellite 101-1, and FIG. 4B shows a second satellite 101-6. FIG. 5A provides an example wherein the separated eighth-cluster 180 is moving in a first direction X and has a larger surface area orthogonal to a direction of motion X. FIG. 5B provides an example wherein the separated eighth-cluster 180 is moving in a first direction X and has a smaller surface area on a front most surface orthogonal to a direction of motion X.

In satellite clusters 100 such as those shown in FIG. 1 and FIG. 2, one or more of the satellites 101-1 to 101-8 is preferably configured to engage one or more adjacent satellites. It is preferable that each of the satellites in a satellite cluster is configured to engage with each adjacent satellite within the cluster and/or in an adjacent cluster of the satellite assembly. In particular, each satellite may be configured to align with one or more adjacent satellites.

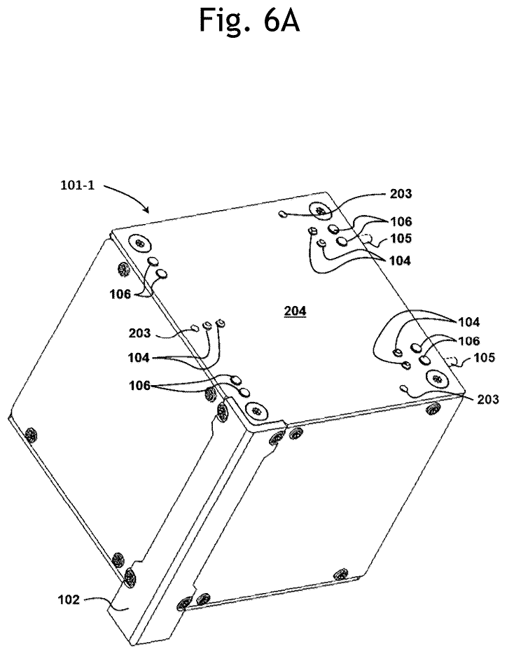

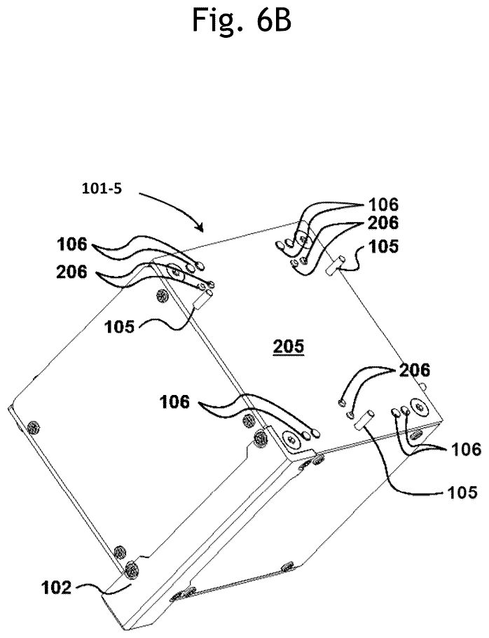

FIG. 6A and FIG. 6B illustrate satellites configured to engage each other as adjacent satellites in a cluster or satellite assembly. The satellite 101-1 of FIG. 6A comprises a mating face 204 configure to be adjacent to, or in contact with, a corresponding mating face 205 of adjacent satellite 101-5 of FIG. 6B when the satellites are in a cluster or satellite assembly, before separation. The satellite 101-1 of FIG. 6A and the satellite 101-5 of FIG. 6B each comprise a plurality of magnets 106. The magnets 106 are configured to align with corresponding magnets 106 of one or more adjacent satellites. The magnets 106 are preferably configured to attract the satellite 101-1 to the one or more adjacent satellites 101-5. In particular, the magnets 106 may be configured to provide an attractive force between the satellite 101-1 and corresponding magnets 106, or a magnetic surface, on an adjacent satellite 101-5. The magnets 106 are preferably permanent magnets, as this may reduce the power required to operate the magnets and provide a simple, passive means of satellite alignment.

The attractive force provided by the magnets 106 is preferably weak enough to be readily overcome by a repulsive force generated by the disengagement mechanism during separation of the satellites in orbit. In this way, the magnets may be configured to aid in aligning adjacent satellites during assembly of the cluster or satellite assembly, and subsequently keeping the adjacent satellites in the desired relative orientation until the satellite assembly is deployed, without hindering the separation of the satellites in space.

The satellite 101-1 of FIG. 6A comprises a mating face 204 configure to engage a corresponding mating face 205 of adjacent satellite 101-5 of FIG. 6B when the satellites are in a cluster or satellite assembly, before separation. In particular, the satellite 101-1 of FIG. 6A comprises a plurality guide holes 203, and the adjacent satellite 101-5 of FIG. 6B comprises a plurality of guide pins 105, wherein the guide pins 105 are configured to insert into the corresponding guide holes 203 to align the satellite 101-1 relative to the adjacent satellite 101-5. In particular, in the satellite 101-1 of FIG. 6A the guide holes 203 are provided on mating face 204, and in the satellite 101-5 of FIG. 6B the guide pins 105 are provided on corresponding mating face 205. In this way, the mating face 204 and corresponding mating face 205 may be readily aligned.

Each satellite preferably comprises a plurality of mating faces configured to engage an adjacent satellite prior to separation. For example, in the cluster 100 of FIG. 1, each satellite preferably comprises three mating faces configured to be inner faces of the cluster 100. In other words, each satellite of a cluster is preferably configured such that each satellite face which adjoins, in other words which faces or opposes, another face of an adjacent satellite, is preferably a mating face. Optionally, outside faces of the cluster may also be mating faces. In particular, in a satellite assembly comprising a plurality of clusters, one more of the satellites of a cluster may comprise one or more mating faces configured to engage adjacent satellites within the same cluster and optionally may also comprise one or more mating faces configured to engage adjacent satellites of an adjacent cluster. Each mating face preferably comprises guide pins 105 and/or guide holes 203 configured to engage corresponding guide holes 203 and/or guide pins 105 of the corresponding adjacent mating face. Furthermore, each mating face preferably also comprises one or more magnets 106 as described above with reference to FIGS. 6A and 6B.

In a preferred arrangement, the plurality of guide pins 105 is configured to provide an electrical connection between the satellite and the adjacent satellite. Alternatively, or additionally, as shown for example in FIGS. 6A and 6B, one or more of the satellites 101-1, 101-5 may comprise at least one connection pin 104 configured to provide an electrical connection between the satellite 101-1 and an adjacent satellite 101-5. As shown, for example, in FIG. 6A, the adjacent satellite 101-5 may comprise a receiving connector 206 configured to receive the connection pin 104 of the satellite 101-1. The at least one connection pin 104 is preferably a spring-loaded pin. Each of the satellites of the cluster may be electrically connected via the connection pins.

During assembly, the guide pins 105 mate with the corresponding guide holes 203 of the adjacent satellites. The assembled cluster 100 can then be readily loaded into any deployment system 500. The permanent magnets 106 provide a small attractive force intended to adhere the satellites into the cluster until disengagement, after deployment of the satellite assembly. The connection pins 104 desirably provide interface for power and/or signal sharing between the satellites in the cluster. The connection pins are optionally spring-loaded pins which may have a benefit of being configured to provide an additional force between the adjacent satellites that may enhance the effect of the disengagement mechanism. This may reduce the likelihood of a failed separation. Once the satellites are assembled into a cluster 100, the combination of the guide pins 105 and permanent magnets 106 may keep the satellites from becoming misaligned or separated prematurely.

### [Satellite/Disengagement Mechanism]

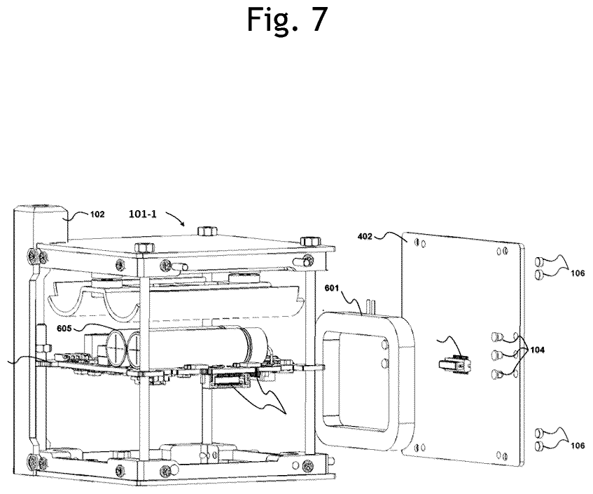

One or more of the satellites of the satellite assembly may comprise a disengagement mechanism configured to separate the satellite from one or more adjacent satellites of the satellite assembly. An exploded view of the satellite 101-1 of FIG. 6A, comprising a disengagement mechanism, is provided in FIG. 7. The satellite disengagement mechanism comprises one or more disengagement coils 601 configured to generate a repulsive electromagnetic force to separate the satellite 101-1 from the one or more adjacent satellites. The disengagement coils are electromagnetic coils.

The satellite disengagement mechanism comprises a bulk capacitor 605, and a driver circuit 608. The driver circuit 608 may be provided on a printed circuit board (PCB). The driver circuit 608 is configured to discharge an electric charge held within the bulk capacitor 605 through the disengagement coils to induce a magnetic field in the one or more disengagement coils 601 of the satellite 101-1.

Each satellite preferably comprises a plurality of disengagement coils 601. In particular, each satellite desirably comprises three disengagement coils 601. The three disengagement coils may be arranged orthogonally to each other such that each engagement coil provides a repulsive force between the satellite 101-1 and an adjacent satellite in a different translational degree of freedom. Each disengagement coil 601 may be associated with a corresponding mating face. In particular, each disengagement coil 601 may be configured to force the satellite away form an adjacent satellite of the satellite assembly. In other words, each of the three disengagement coils is preferably disposed on a different side of the satellite, wherein each of the three sides of the satellite is configured to face a side of an adjacent satellite prior to separation. The driver circuit 608 is preferably configured to discharge the electric charge held within the bulk capacitor 605 through a plurality of disengagement coils 601 of the satellite 101-1 simultaneously. The driver circuit 608 is optionally configured to discharge the electric charge held within the bulk capacitor 605 through all of the disengagement coils 601 of the satellite 101-1 simultaneously.

The satellite 101-1 of FIG. 7 comprises at least one connection pin 104 configured to provide an electrical connection between the satellite 101-1 and the one or more adjacent satellites 101-5. The driver circuit 608 may be configured to discharge the electric charge held within the bulk capacitor 605 through the plurality of disengagement coils 601 in response to receiving a synchronisation signal through the at least one connection pin 104. In this way, a repulsive force created by a plurality of disengagement coils 601 of a satellite 101-1 may be synchronised.

A satellite assembly may include a first satellite 101-1 comprising a first disengagement coil 601 and a second satellite comprising a second disengagement coil. The first disengagement coil 601 is disposed on a first side of the first satellite 101-1. The second disengagement coil is disposed on a second side of the second satellite. Prior to separation, the first side and the second side face each other. In other words, the disengagement coil of the first satellite may be disposed adjacent the mating face of the first satellite, and the disengagement coil of the second satellite may be disposed adjacent the corresponding mating face of the second satellite. In this way, the first and second satellites may be separated by a repulsive force between the two disengagement coils. The driver circuit 608 may be configured to discharge the electric charge held within the bulk capacitor 605 through a plurality of disengagement coils corresponding to mating faces of adjacent satellites simultaneously in response to receiving a synchronisation signal through the at least one connection pin 104. In particular, the disengagement mechanism may comprise a disengagement controller 607. The disengagement controllers 607 of adjoining satellites may be synchronised through the connection pins 104 on the mating faces of the satellites. Following synchronisation, the driver circuitry 608 on each satellite is configured to discharges its bulk capacitance through the corresponding disengagement coils, simultaneously. This induces magnetic fields in the powered disengagement coils, with like poles forming at the mating faces of the satellites, which causes the satellites to repel one another.

The disengagement mechanism using electromagnetic disengagement coils may provide a large repulsive force in a short duration. As such, a significant repulsive force may be imparted to the satellite before it becomes too far from the remaining satellites for the force to be effective. Furthermore, the use of a short, high current pulse from the bulk capacitor means a large force may be provided without overheating the coils. Thus, the satellites may repel away and set on different trajectories with a relatively low risk of damage to the satellites during separation.

The one or more of the disengagement coils 601 may optionally be configured to contribute to attitude control of the satellite. In particular, the disengagement coils may be used as part of a magnetorquer to adjust the attitude of the satellite using magnetic torque. In this way, there may be an efficient use of the coils as components used for the purpose of satellite separation and attitude adjustments.

### [Deployment/Dispersal Method—Overview]

Satellites may be deployed from the satellite assembly by: disposing the satellite assembly inside a launch vehicle; controlling the launch vehicle to deploy the satellite assembly into an initial orbit. Optionally, the satellite assembly may be disposed in a deployment system 500 and deployed in the initial orbit from the deployment system 500. The satellite assembly may then be controlled to separate satellites from the satellite assembly in a sequence.

The sequence may include separating satellites from the at least one cluster 100 such that a separated sub-cluster of satellites is separated from a remaining sub-cluster. The sequence preferably includes sequentially separating satellites from the separated sub-cluster until each satellite has been separated, for example as described above with reference to FIGS. 6A and 6B.

The separated satellites may be set into different altitudes and orbital planes, around any planet with a gaseous atmosphere, using differential drag and/or using differential nodal precession.

Differential drag techniques describes when two sub-cluster parts are oriented in such a way, through the use of attitude control, as to create a difference in the magnitudes of drag force experienced between the two sub-clusters. The attitude of the separated sub-cluster may be adjusted to increase an amount of differential drag between the separated sub-cluster and the remaining sub-cluster. For example, the satellite included in the separated sub-cluster may be selected based on an estimated differential drag of the separated sub-cluster. Alternatively, or additionally, the orientation of the separated sub-cluster may be adjusted based on differential drag. For example, the half-cluster 120 of FIG. 3A may have a ballistic coefficient ratio approximately twice that of the half-cluster 120 of FIG. 3B, when these half-clusters are moving in the X-direction, because a surface area orthogonal to the X-direction is twice as large for the half-cluster 120 of FIG. 3A than for the half-cluster of FIG. 3B. Similarly, the quarter-cluster 140 of FIG. 4A may have a ballistic coefficient ratio approximately 2.4 times that of the quarter-cluster 140 of FIG. 4B, when these quarter-clusters are moving in the X-direction. Furthermore, the eighth-cluster 180 of FIG. 5A may have a ballistic coefficient ratio approximately 1.3 times that of the eighth-cluster 180 of FIG. 5B, when these half-clusters are moving in the X-direction.

Differential lift describes when two sub-clusters are oriented in such a way, through the use of attitude control, as to create a difference in the direction or magnitude of the lift force experienced between two sub-clusters. The attitudes of the sub-clusters may be adjusted to increase the amount of lift acting upon them. Desirably, the attitudes of the different sub-clusters may be adjusted to increase an amount of lift acting on them in different directions. For example, the sub-clusters may be adjusted to increase the amount of lift acting on the sub-clusters in opposing directions to each other. In this way, the amount of differential lift between the separated sub-cluster and the remaining sub-clusters may be increased. For example, the satellites in the separated sub-cluster may be oriented in such a way that experiences the lift force along the cross-track direction whilst the remaining sub-cluster is oriented in a similar way to experience lift in the opposing direction. Consequently, this introduces a secular drift in the orbital inclinations of the two sub-clusters causing their orbital planes to shift in opposing directions.

Differential nodal precession describes when, due to differences in inclination and altitude between two satellites, the orbital planes of the two satellites rotate around the Earth, or any other planet, in inertial space at different rates.

A combination of differential draft and differential nodal precession may be used to disperse the satellites of the satellite assembly such that the satellites are set on different orbital trajectories around the Earth, or any other planet, to provide a desired level of coverage.

### [Detail of Dispersal Methods]

Any orbit size, shape and orientation can be described through five independent Keplerian orbital elements: semi-major axis, a; eccentricity, e; inclination, l; longitude of the ascending node, Ω; and argument of periapsis, ω. These permit those of ordinary skill in orbital mechanics to calculate the position of the satellite along its orbit, given its time of perigee passage.

Satellites orbiting around the Earth, and many other planets with a gaseous atmosphere, experience, to a varied extent, a drag force opposite in direction to the velocity vector and at a magnitude determined by the semi-major axis, or altitude, of the orbit. For the latter, the influence is two-fold. Firstly, by Kepler's third law of planetary motion, the orbital velocity is a proportional to the semi-major axis, or the radius of the orbit in the case of circular orbits. Secondly, it relates directly to the free-mean path of the residual atmosphere, which in turn determines the extent of atmospheric drag experienced by the satellite. The drag force can be determined from the following expression:

$$\vec{{F}_{D}} = - 0.5 p s {C}_{D} v \vec{v} \qquad ( 1 )$$

Wherein,
   p is the atmospheric density at the satellite's altitude;
   s is the projected surface area of the satellite in the direction of the velocity vector;
   C_{D} is the drag coefficient; and
   v is the magnitude of the velocity vector.

For satellites orbiting at the same altitude, maximising the difference in drag between two satellites is a matter of the maximizing difference of the product of s and C_{D} for the two satellites, which is achievable through attitude manoeuvres.

Similarly, aerodynamic interactions between the satellite and the residual atmosphere results in a lift force, which acts perpendicularly to the drag. Through attitude control, this lift force can be exploited to introduce a secular drift in the orbital plane, through the gradual change of the orbital inclination (as disclosed in O. Ben-Yaacov and P. Gurfil, “Stability and Performance of Orbital Elements Feedback for Cluster Keeping Using Differential Drag”, Journal of the Astronautical Sciences, vol. 61, no. 2, pp. 198-226, 2014, issn: 21950571. doi: 10.1007/s40295-014-0022-0). This lift force is given by the equation:

$$\vec{{F}_{L}} = - 0.5 p s {C}_{L} ‖ {v}^{2} ‖ \frac{( \vec{v} \times \vec{n} ) \times \vec{v}}{‖ ( \vec{v} \times \vec{n} ) \times \vec{v} ‖} \qquad ( 2 )$$

Wherein,
   C_{L} is the lift coefficient; and
   \vec{n} is the normal of the velocity vector.

For satellites with the same orbital parameters, adjusting the attitude of the satellites such that the lift force acts in opposing direction introduces differential lift between the satellites. Furthermore, if these opposing forces act along the cross-track direction, the orbital inclinations will secularly shift in opposing directions, which is also achievable through attitude control.

For Earth orbits, the nodal precession, or more pertinently, the precession of the right ascension of the ascending node (RAAN) is expressed through the derivative:

$$\dot{{Ω}_{J 2}} = - \frac{3}{2} \cdot n \cdot cos ( i ) \cdot {J}_{2} \cdot {( \frac{{R}_{E}}{a ( 1 - {e}^{2} )} )}^{2} \qquad ( 3 )$$

Wherein,
   J₂ is a constant equal to 1.08262668×10⁻³; and
   R_{E} is the radius of Earth and u is the Standard Gravitational Parameter of Earth.

This rate of precession is experienced by all satellites orbiting the Earth at rates dependant on the satellite's orbits altitude, inclination and eccentricity. Similar scenarios arise in respect of other planets. Differential nodal precession for two satellites describes a different rate of precession between two satellites. In the satellites of the present invention, this is primarily achieved through decaying the semi-major axis of the satellites at different rates, through the use of the aforementioned differential drag. Secondarily, the satellites of the present invention may be disengage from a cluster either the in-track or the cross-track components of the velocity vector, or any other angle between these two components, to generate a difference in the orbit inclinations, and thus a difference in their nodal precession.

### [Initial Orbit and Attitude Control Manoeuvres]

The preferred launch inclination ‘l’ for deployment of each satellite 101-1 to 101-8 may be towards the upper end of the range between 0 and 90 degrees as a prograde orbit, with a more preferred range between 80 and 90 degrees. The actual inclination in practice will be dependent on the launch vehicle and the requirement of any other satellites/missions being launched from the same launch vehicle in a common “rideshare” scenario. Most rideshare services offer initial orbits around the Earth with the following properties: altitude: 500-600 km; and inclination: Polar/Mid-range Earth orbits. In the case of other planets, orbital injection may be accomplished at various altitudes and inclinations, and would depend upon specific mission objectives and the respective gravitational and atmospheric conditions.

An example a procedure for separating a cluster 100 into two half-clusters 120 is as follows. The cluster 100 is put into an initial orbit, for example by deployment form a deployment system 500 launched in a launch vehicle, which may be shared by other satellites. The cluster 100 may undergo a process to assign a master controller from among the plurality of satellites 101-1 to 101-8 in the cluster 100. This master controller, or master satellite, is responsible for ensuring that all the 101-1 to 101-8 in the cluster 100 pass their system checks, synchronisation during disengagement, attitude control and for communications with the ground station.

The cluster 100 may then perform attitude manoeuvres such that the communications antenna 103 of the master satellite 101-1 becomes Nadir pointing. The cluster 101 may remain idle or in a receiving-mode until a predetermined time, for example of 45 minutes, elapses. During this predetermined time period, the cluster 100 would maintain an attitude such that the antenna 103 of the master satellite 101-1 is Nadir pointing. After the predetermined time has elapsed, the cluster 100 may establish a communications link with a ground station.

Once communications between the cluster 100 and the ground station is established, the master satellite 101-1 may then wait for a disengagement command from the ground station. Once the disengagement command is received, the cluster 100 may enter a disengagement state. The disengagement state is preferably a low power state where priority is given to tasks required for disengagement. The tasks required for disengagement may include pulse synchronisation, and charging the bulk capacitor to a predetermined target voltage. The cluster 100 may then perform attitude manoeuvres as to assume a predetermined attitude aligned with the desired direction of disengagement.

Once the cluster is in the predetermined attitude and is aligned with the desired direction of disengagement, the cluster 100 may begin the disengagement synchronisation. Any non-essential system on each satellite 101-1 to 101-8 of the cluster 100 would be switched off for disengagement. The disengagement controller 607 on each of the satellites 101-1 to 101-8 preferably disables all interrupts, and initialises the respective synchronisation input captures to remain idle until the disengagement signal is received by each satellite 101-1 to 101-8. Once all bulk capacitors 605 are charged and all satellites 101-1 to 101-8 are idle, the master satellite 101-1 may issue the disengagement signal. The disengagement synchronisation process shall be understood to comprise all the aforementioned tasks, beginning from switching off unnecessary subsystems and ending with the issuance of the disengagement signal.

On reception of the disengagement signal, all satellites 101-1 to 101-8 may simultaneously discharge their respective bulk capacitors 605 through their disengagement coils. These pulses generate a repulsive electromagnetic force that separates the cluster 100 into two half-clusters 120.

Once the cluster 100 has been separated into sub-clusters, such as the half-clusters 120, the dispersal procedure may begin. Upon separation, the half-clusters 120 may begin the dispersal procedure, whereby the half-clusters 120 perform attitude manoeuvres such that the atmospheric drag of the half-cluster 120 with the highest velocity vector may be increased, and desirably maximised, whilst the atmospheric drag of the other half-cluster 120 with the lowest velocity vector may be decreased, and desirably minimised. The half-cluster 120 with the highest differential drag may experience a larger decay in the semi-major axis (or altitude), this may cause the velocity vector of that half-cluster 120 to increase at a rate higher than that of the other half-cluster 120. This desirably causes the satellites to separate along the in-track component of the velocity vector. Furthermore, since the semi-major axis of the two half-clusters become different, the half-clusters 120 will experience a differential nodal precession causing their orbital planes to separate in inertial space. These attitudes may be maintained until a predetermined, mission-specific, separation between satellites is achieved. In the case of disengagement with a cross-track component, a small difference in the inclinations of the half-clusters 120 would also be present, which contributes to the differential nodal precession.

The disengagement process may be encompassed by the following tasks:
1. Selection of the master satellite,
2. Awaiting the disengagement command from the ground station,
3. Entering the disengagement state,
4. Performing the synchronisation process,
5. Discharging the bulk capacitors through the disengagement coils,
6. Performing the dispersal procedure.

Similarly, the disengagement process is repeated such that the two half-clusters 120 become four quarter-clusters 140, and again such the quarter-clusters become eight sub-clusters 180 corresponding to the eight satellites 101-1 to 101-8.

It is known that the RAAN rate of precession is higher for orbits at lower inclinations. However, the rate of precession decreases rapidly at higher inclinations. Therefore, to obtain larger difference in the rate of precession, a higher initial inclination should be chosen as a smaller difference in inclination will result in a larger difference in precession rates. Furthermore, from the equation for RAAN precession, as the semi-major axis increases, the rate of precession should decrease. In general it can be shown that to maximise passive separation, a higher prograde inclination should be chosen at a lower semi-major axis. Furthermore, to further increase differential nodal precision, a larger delta-v should be applied by the disengagement mechanism.

### [Example of Swarm Deployment and Dispersal (in Track)]

An example of satellite swarm deployment and in-trach dispersal is provided as follows. The swarm of the present example comprises eight picosatellites 101-1 to 101-8 forming a cluster 100. The cluster 100 has been deployed with an initial circular orbit with the following orbital parameters: altitude: 500 km; inclination: 86°; initial RAAN: 0°; initial argument of periapsis: 0°; eccentricity: 0.

In this example, the first disengagement, from a full cluster 100 to two half-clusters 120, occurs seven days post deployment of the cluster 100 from a deployment system 100. The disengagement is performed such that half-clusters 120 experience an instantaneous delta-v of 0.35 m/s along the in-track component of velocity in opposing directions, respectively. It can be understood that since the orbit is circular, and since no inclination change manoeuvres have occurred, the only significant changes in the orbital parameters will be in the altitude and in the RAAN. After 3 months in orbit with the dispersal procedure described in this patent, these parameters will have drifted to the following values, where in Table 1 Sat 1 is a first half-cluster and Sat 2 is a second half-cluster separated from the initial cluster 100.

TABLE 1

| | Sat 1 | Sat 2 |
|---|---|---|
| Altitude | 484 km | 480 km |
| RAAN | 308° | 307.5° |

Following the same procedure with the same delta-v for each half-cluster 120, four resulting quarter-clusters 140 are dispersed for another 3 months. The altitudes and RAAN values would now have shifted to the following values, where in Table 2 Sat1-4 are the four different quarter-clusters 140 separated from the initial cluster 100.

TABLE 2

| | Sat 1 | Sat 2 | Sat 3 | Sat 4 |
|---|---|---|---|---|
| Altitude | 483 km | 481 km | 479 km | 477 km |
| RAAN | 260° | 259.5° | 259.3° | 259° |

Finally, the same procedure is followed for the final set of disengagement resulting in the eight separated satellites 101-1 to 101-8. Optionally, depending on mission requirements, the mission to be performed by the satellites may begin immediately after the final disengagement, bringing the deployment for example case to around 6 months duration. In the meantime, after final separation, the satellites will continue to drift apart for around two more years until the first satellite undergoes re-entry. At which point, the altitudes and RAAN values would look like the following, where in Table 3 Sat1-8 are eight separated satellites 101-1 to 101-8.

TABLE 3

| | Sat1 | Sat2 | Sat3 | Sat4 | Sat5 | Sat6 | Sat7 | Sat8 |
|---|---|---|---|---|---|---|---|---|
| Altitude (km) | 410 | 402 | 397 | 387 | 355 | 329 | 311 | Re-entry |
| RAAN | 175° | 173.5° | 172.5° | 171.5° | 171° | 169.4° | 168.4° | 166.2° |

For this example, in order to bolster the swarm with additional satellites, a launch date after the final disengagement would be recommended, which would be 6 months in this case. An additional launch of a further eight satellites around 6 months after the final disengagement of the initial cluster would lead to around 1.5 years with 16 satellites in orbit. In order to replenish, the initial eight satellites on re-entry, on the other hand, a launch date at least 6 months before the first re-entry would be recommended, to allow for the complete deployment of the second cluster.

It is understood that the figures stated for the initial orbit and for the dispersal periods are illustrative and provided only for the purpose of this example. In practice, the initial orbit would be set by the launch service and the dispersal periods would be mission specific. It is appreciated that those with ordinary skill in the area may modify this dispersal period to achieve the ideal separation between satellites and their ideal coverage for their specific application.

### OTHER CONSIDERATIONS

An argument can be made on the risk of mission failure due to multiple satellites being dependent on their disengagement from the cluster. The perceived risks here arise from two different sources, including mechanical failure during launch and, electrical and mechanical failure due to the space environment. For both cases, the risks are well understood and can be greatly mitigated by following industry standards with respect to design, testing and qualification. Furthermore, the dependence of a satellite to the cluster is solely limited to the disengagement. As such, a failure in one satellite, particularly if that failure is not related to the disengagement mechanism, does not propagate or impact the functionality of another. In the case of failure in the disengagement mechanism itself, this does not necessarily preclude the mission from proceeding as depending on the mission, it is likely that the satellites can be configured to also perform mission specific functions in a cluster, half-cluster or quarter-cluster, by design.

Another argument that may be raised concerns the deployment time associated with this method, which may range from a few months to a year, depending on the mission and desired separations. In this case, it is the prerogative of the mission designer to determine the acceptable trade-off between mission cost and mission lifetime. Furthermore, as in the previous argument, the clustered form, pre-separation does not necessarily preclude the mission from commencing before all disengagements are completed.

Aspects of the present disclosure have been described with particular reference to the examples illustrated. While specific examples are shown in the drawings and are herein described in detail, it should be understood, however, that the drawings and detailed description are not intended to limit the invention to the particular form disclosed. It will be appreciated that variations and modifications may be made to the examples described within the scope of the present invention, as defined by the claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A satellite for inclusion in a satellite assembly comprising a plurality of satellites for deployment in space, to orbit a given planet with a gaseous atmosphere, the satellite comprising a satellite disengagement mechanism configured to separate the satellite from one or more adjacent satellites of the satellite assembly,
wherein the satellite disengagement mechanism comprises one or more disengagement coils configured to generate a repulsive electromagnetic force to separate the satellite from the one or more adjacent satellites.

2. The satellite of claim 1, wherein the satellite disengagement mechanism further comprises a disengagement controller,
wherein the disengagement controller comprises
a bulk capacitor, and
a driver circuit configured to discharge an electric charge held within the bulk capacitor through the one or more disengagement coils to induce a magnetic field in the one or more disengagement coils.

3. The satellite of claim 2, wherein the one or more disengagement coils comprises a plurality of disengagement coils, and
wherein the driver circuit is configured to discharge the electric charge held within the bulk capacitor through the plurality of disengagement coils simultaneously.

4. The satellite of claim 3, further comprising at least one connection pin configured to provide an electrical connection between the satellite and the one or more adjacent satellites,
wherein the driver circuit is configured to discharge the electric charge held within the bulk capacitor through the plurality of disengagement coils in response to receiving a synchronisation signal through the at least one connection pin.

5. The satellite of claim 1, wherein each satellite disengagement mechanism comprises three disengagement coils, wherein each of the three disengagement coils is disposed on a different side of the satellite,
wherein each of the three sides of the satellite is configured to face a side of an adjacent satellite prior to separation.

6. The satellite of claim 1, wherein one or more of the disengagement coils is configured to contribute to attitude control of the satellite using magnetic torque.

7. A satellite assembly comprising:
one or more clusters of satellites,
each cluster of satellites comprising a plurality of satellites arranged in a 1U satellite frame,
wherein each cluster of satellites is configured such that the satellites separate from each other sequentially.

8. The satellite assembly of claim 7, wherein each cluster comprises eight or more satellites.

9. The satellite assembly of claim 8, wherein each cluster comprises a two-by-two-by-two array of satellites.

10. The satellite assembly of claim 7, wherein the satellite assembly comprises a plurality of clusters, and wherein the satellite assembly is configured such that the clusters separate from each other sequentially.

11. The satellite assembly of claim 7, wherein each satellite comprises a plurality of guide pins and guide holes, wherein the guide pins of each satellite are configured to insert into corresponding guide holes of one or more adjacent satellites, to align the satellite relative to the one or more adjacent satellites.

12. The satellite assembly of claim 11, wherein the one or more clusters comprises a plurality of clusters, and wherein the one or more adjacent satellites comprises at least one satellite in an adjacent cluster.

13. The satellite assembly of claim 11, wherein one or more of the plurality of guide pins are configured to provide an electrical connection between the satellite and the adjacent satellite.

14. The satellite assembly of claim 7, wherein each satellite comprises at least one connection pin configured to provide an electrical connection between the satellite and an adjacent satellite.

15. The satellite assembly of claim 14, wherein the at least one connection pin is a spring-loaded pin.

16. The satellite assembly of claim 7, further comprising a satellite disengagement system configured to separate one or more satellites from a remaining one or more satellites of the satellite assembly.

17. The satellite assembly claim 16, wherein the satellite assembly comprises a plurality of clusters, and wherein the satellite disengagement system is configured to separate one or more clusters from a remaining one or more clusters of the satellite assembly.

18. The satellite assembly of claim 17, wherein each cluster comprises two half-clusters, and wherein the satellite disengagement system is configured to separate one of the two half-clusters from the other of the two half-clusters.

19. The satellite assembly of claim 18, wherein each half-cluster comprises two quarter-clusters, and wherein the satellite disengagement system is configured to separate one of the two quarter-clusters from the other of the two quarter-clusters.

20. A satellite assembly comprising one or more clusters of satellites, each cluster of satellites comprising a plurality of satellites arranged in a 1U satellite frame, wherein each cluster of satellites is configured such that the satellites separate from each other sequentially, wherein at least one of the satellites comprises a satellite disengagement mechanism configured to separate the satellite from one or more adjacent satellites of the satellite assembly, wherein the satellite disengagement mechanism comprises one or more disengagement coils configured to generate a repulsive electromagnetic force to separate the satellite from the one or more adjacent satellites.

21. The satellite assembly of claim 20, wherein the satellites include a first satellite comprising a first disengagement coil and a second satellite comprising a second disengagement coil,
wherein the first disengagement coil is disposed on a first side of the first satellite,
wherein the second disengagement coil is disposed on a second side of the second satellite, and
wherein, prior to separation, the first side and the second side face each other.

22. A method of deploying satellites from a satellite assembly according to claim 7, the method comprising:
disposing the satellite assembly inside a launch vehicle;
controlling the launch vehicle to deploy the satellite assembly into an initial orbit; and
controlling the satellite assembly to separate satellites from the satellite assembly in a sequence.

23. The method of claim 22, wherein the sequence includes separating satellites from the at least one cluster such that a separated sub-cluster of satellites is separated from a remaining sub-cluster, wherein the attitude of the separated sub-cluster is adjusted to increase an amount of differential drag between the separated sub-cluster and the remaining sub-cluster.

24. The method of claim 23, further comprising selecting which of the plurality of satellites are included in the sub-cluster based on an estimated differential drag of the separated sub-cluster.

25. The method of claim 24, wherein the sequence includes sequentially separating satellites from the separated sub-cluster until each satellite has been separated.

26. The method of claim 25, further comprising setting the separated satellites into different altitudes and orbital planes using differential drag and/or differential nodal precession and/or differential lift.

27. The method of claim 22, wherein the sequence includes separating satellites from the at least one cluster such that a separated sub-cluster of satellites is separated from a remaining sub-cluster, wherein the attitude of the separated sub-cluster is adjusted to increase an amount of differential lift between the separated sub-cluster and the remaining sub-cluster.
